(19) United States
(12) Patent Application Publication
(10) Pub. No.: US 2005/0286576 A1
(43) Pub. Date: Dec. 29, 2005

(54) Apparatus and method for controlling the power of a laser beam

(76) Inventors: Alistair Gill, Thaining (DE); Peter Dullin, Munchen (DE)

Correspondence Address: DUANE MORRIS LLP, Suite 700, 1667 K Street, N.W., Washington, DC, 20006, US

(21) Appl. No.: 10/960,694

(22) Filed: Oct. 8, 2004

(30) Foreign Application Priority Data
Jun. 23, 2004 (DE) 20 2004 009 856.3

(51) Int. Cl. H01S 3/13

(52) U.S. Cl. 372/29.021; 372/98

(57) ABSTRACT

An apparatus and method for controlling the power of a laser beam is described. In one embodiment a rotatable Brewster element, rotated by a drive means, is disposed in the propagation path of a laser beam and is aligned along the an axis parallel to the direction of propagation of the laser beam. At least one stationary Brewster element is also disposed in the propagation path of the laser beam. Measuring means is provided to determine the power of the laser beam downstream of the rotatable Brewster element and to generate an actual power value. A control means receives the actual power value from the measuring means, compares it with the desired power value, and provides a control signal for the drive means. The drive means rotates the rotatable Brewster element in response to the control signal in order to minimize the difference between the actual power value and the desired power value. According to the invention, the rotatable Brewster element thus is used as an adjuster in a control loop for controlling the power of a laser beam.

### PRIORITY CLAIM

The instant application claims the filing date priority benefit of German Utility Model Application 20 2004 009 856.3 filed on Jun. 23, 2004 , the entirety of which is hereby incorporated herein by reference.

### FIELD OF THE INVENTION

The present invention relates to an apparatus for controlling the power of a laser beam, especially the power of a laser beam emitted by a CO₂ laser.

### BACKGROUND OF THE INVENTION

The inherent instability of the power output is one of the biggest problems with the use of CO₂ lasers. This instability is caused by a variety of factors, among them variation of the cooling water temperature, propagation and contraction of the resonant cavity, and changing of the operating point by variations in modulation. The latter occurs when applications require different levels of power, e.g. in bitmap grey scale marking or cutting, applications needing different speeds, and the like.

Most manufacturers of CW (continuous wave) CO₂ lasers specify their products as having a stability within ±7% after a “warm-up phase”. During this warm-up phase, numerous leaps may occur in the output phases of the laser, depending on the type and structure of the resonant cavity.

Certain process applications require a much higher degree of power stability in continuous operation, too, when materials are subjected to high precision processing, such as applying grey scale images by scanning onto glass or plastics.

It is already known to use optical filters and modulators to stabilize the laser power output subsequent to the warm-up phase.

For example, acousto-optical modulators by such manufacturers as Isomet Corporation of Springfield, Va., U.S.A. and Neos Technology, of Melbourne, Fla., U.S.A. are used for this purpose. However, even with the use of acousto-optical modulators, for many applications the stability of the power output of a CO₂ laser so far could not be improved to full satisfaction.

European patent EP 1 246 712 by the same applicant discloses a method and an apparatus for controlling the power of a laser beam in dependence upon the movement of the laser beam across a target. The apparatus comprises a deflector unit to move the laser beam across the target and at least one rotatable Brewster plate which is arranged in the propagation path of the laser beam. It further comprises a drive means to rotate the Brewster plate. The Brewster plate is controlled in response to the movement of the deflector unit and thus of the laser beam on the target to make sure that the laser beam will always emit constant power to the target, conform with the movement of the laser beam on the target. The cited document does not provide for control of the laser power, particularly not for fine control of the power output of a CO₂ laser, nor for compensation of the inherent instabilities.

European patent application EP 1 308 235 by the same applicant specifies a method of controlling the laser beam energy of a laser beam by means of two Brewster elements aligned along an axis in parallel with the direction of the laser beam. The Brewster elements are rotated about this axis, the first one in one direction and the other one in the opposite direction. More specifically, the two Brewster elements are rotated at the same time by the same angular amount so as to adjust the laser power output to a value between 0% and 100% of the maximum power of the CO₂ laser. It is not provided that the laser power be controlled, nor is it provided that the inherent instabilities of a CO₂ laser be compensated.

The applicant's above mentioned protective rights are based on the concept of making use of a member to control the laser power which member is known for controlling the polarization of a light beam, namely a Brewster element or Brewster plate, in the following as referred to as Brewster element. Starting from a light beam, especially a laser beam which has only one direction of polarization, a Brewster element adjusted to the right Brewster angle, in theory, may be employed to transmit between 0% and 100% of the polarized radiation, while being rotated through an angle of between 0° and 90°. Different materials and coatings are selected for Brewster elements, depending on the type of laser. For instance, ZnSe plates are the preferred. Brewster elements for control of the energy of a carbon dioxide (CO₂) laser. Different coatings may be applied to the surfaces of Brewster elements so that maximum and minimum transmissions, output polarization, and the necessary rotation of the Brewster elements for controlling the transmission may be varied. In practice, the maximum transmission of a Brewster element of the kind described is approximately 99.98% . Moreover, in practice, the attenuation of a single Brewster element often is not sufficient to adjust zero percent transmission.

For a better understanding of the background of the present invention the function of Brewster elements will be discussed in greater detail below with reference to FIGS. 1 to 4.

FIG. 1 illustrates how a laser beam which is polarized either in P pol direction (parallel) or in S pol direction (vertical) can be reflected or transmitted by a single Brewster element 200. For purposes of illustration, both the P polarization and S polarization are shown in the drawing. However, a person skilled in the art will appreciate that, in practice, a CO₂ laser beam will have essentially only one kind of polarization (linear polarization). With reference to FIG. 1, the beam will be reflected if the entry polarization is P pol, and the entering beam will be transmitted if the entry polarization is S pol.

Moreover, the laser beam is offset by a factor which results from the incident angle, as determined by the Brewster angle, and from the thickness of the Brewster element.

Turning to FIG. 2, it shows the Brewster element 200 having been rotated through 90°, only the P pol beam having been transmitted, while the S pol beam is reflected. The laser beam is offset by exactly the same factor as in FIG. 1, yet it differs by having been rotated by 90° around the center line.

FIG. 3 shows two Brewster elements 450, 452 arranged towards each other so as to allow the exiting beam of the laser not to be offset with respect to the entering beam of the laser since the second Brewster element 452 compensates the parallel offset introduced by the first Brewster element 450. In actual fact, depending on the coating of the Brewster elements 450, 452, the portion of the P pol laser beam reflected by the first Brewster element 450 will comprise a very high percentage of the P pol entry beam so that only a minor percentage need be reflected by the second Brewster element 452.

FIG. 4 shows the two Brewster elements 450, 452 which are rotated at the same time in the same direction. As the rotation progresses, the proportion of the P pol beam reflected by the first Brewster element 450 decreases and the P pol transmissivity increases. Accordingly, the proportion of the S pol laser radiation transmitted by the first Brewster element 450 decreases and the reflection of the S pol laser radiation increases with progressing rotation.

It is important to note that the laser beam polarization leaving the first Brewster element 450 is rotated when the first Brewster element 450 rotates, in response to the coating thereof. Thus it may be gathered from FIG. 4 that the P pol laser radiation transmitted by the first Brewster element 450 is reflected by the second Brewster element 452. S polarization transmitted by the first Brewster element 450 is transmitted also by the second Brewster element 452.

Therefore, power control is not substantially influenced in addition by the second Brewster element 452. However, the latter is essential for correcting the beam offset of the laser beam caused by the first Brewster element.

When making use of the method illustrated in FIG. 4 the two Brewster elements 450, 452 are rotated jointly through 90° to control transmission or permeability from maximum to minimum and to compensate the offsetting of the laser beam.

It is an object of the invention, starting from the prior art discussed above, to provide an apparatus for controlling the power of a laser beam, suited in particular for power stabilization of CO₂ lasers. This object is met by an apparatus which comprises the features recited in claim 1.

### SUMMARY OF THE INVENTION

The apparatus according to the invention comprises a rotatable Brewster element aligned along an axis parallel to the direction of the laser beam and disposed in the propagation path of the laser beam. A drive means, such as a galvanometer scanner is connected to the Brewster element to rotate the same. A measuring means is provided to determine the power of the laser beam downstream of the rotatable Brewster element and to generate an actual power value. At its input, the control means receives the actual power value from the measuring means, compares it with the desired power value, and provides a control (adjustment) value for the drive means at its output. The drive means rotates the rotatable Brewster element in response to the control value in order to minimize the difference between the actual power value and the desired power value. According to the invention, the rotatable Brewster element thus is used as an adjuster in a control loop for controlling the power of a laser beam. Variations in intensity of the power output of, for instance, a CO₂ laser can be eliminated quickly with this kind of control particularly when using high speed galvanometric motors. It could be demonstrated by testing in practice that, after the warm-up phase, the intensity of a CO₂ laser was kept stable within a range of ±0.3%. Even during the warm-up phase the laser power could be controlled to a rated value with a deviation of no more than ±1.3%.

The apparatus according to the invention permits both control of the power output of a laser to a constant value, thereby balancing variations in intensity, and going through a given power profile by presetting a corresponding profile of desired values.

In an especially preferred embodiment of the invention the rotatable Brewster element is used together with a stationary Brewster element arranged directly behind the rotatable Brewster element in the propagation path of the laser beam. It is likewise conceivable to arrange a stationary Brewster element each in front of and behind the rotatable Brewster element. In that case both the rotatable and fixed Brewster elements should be positioned upstream of the measuring means.

Using a stationary Brewster element in combination with a rotatable Brewster element has a number of advantages. As explained above, rotation of the Brewster element causes also the polarization of the laser beam passing through this Brewster element to rotate. The transmitted part of the laser beam which subsequently impinges on the stationary Brewster element is rotated by this Brewster element back into its original polarization plane. In view of the fact that the effect of a Brewster element depends on the polarization of the incident light beam, also the stationary Brewster element contributes to reducing the power of the laser beam (with rotated polarization). Consequently an arrangement which comprises a rotating Brewster element and a stationary Brewster element offers a higher degree of efficiency than a system with but one rotatable Brewster element. Compared with the known apparatus discussed above which includes two rotatable Brewster elements, the apparatus according to the present invention has the advantage of being simpler and less expensive to manufacture. Moreover, the system is faster because the inertia is lower since there is only one rotating Brewster plate.

True, the beam offset described above cannot be fully compensated by a system composed of rotable and stationary Brewster elements. However, adequate positioning of the laser source and optical components within the laser housing still can provide a laser output beam which lies in a desired plane.

It could be shown in practice that one rotatable Brewster element is sufficient to stabilize the power in a power range of from 15 to 100% of the power output. On the other hand, a combination of rotatable and stationary Brewster elements should be provided for power stabilization and control in a wider range. The stationary Brewster element, furthermore, is needed to turn back the polarization direction to the original polarization plane of the laser source. That may be necessary to fulfill certain requirements of a laser output signal, and it may be recommendable regarding downstream optical elements, such as beam splitters, modulators and the like which often operate in dependence upon polarization.

In another preferred embodiment, a second rotatable Brewster element is associated with the rotatable Brewster element. It may be arranged directly downstream or upstream of the rotatable Brewster element first mentioned and along the same axis in the propagation path of the laser beam. The first and second rotatable Brewster elements, preferably, are rotatable in opposite directions. More specifically, they are rotated in synchronism by the same angular amount, in opposite directions. In an especially preferred embodiment of this variant, the first and second rotatable Brewster elements each are designed to be rotatable synchronously by about 0 to +45° and 0 to −45°, respectively, so as to control the transmission of the laser beam from maximum to minimum and vice versa. Providing a second rotatable Brewster element has the advantage of enlarging the dynamic range for power reduction or transmission of the laser beam, extending at least from 0 to 98% transmission. Moreover, two rotatable Brewster elements connected in series allow a shorter reaction time and, furthermore, smaller angles of rotation (0 to 45°) can be achieved than with only one rotatable Brewster element (0 to 90°).

In a preferred embodiment, the measuring means comprises an active power meter and a beam splitter which is disposed in the propagation path of the laser beam and directs a defined portion of the laser beam onto the active power meter. The part of the laser beam which is deviated by the beam splitter should be as small as possible in order not to reduce the power output too much.

The control means preferably comprises a PID controller which includes a proportional controller portion, an integral controller portion, and a differential controller portion. In a preferred embodiment this is implemented by software in an electronic control unit. In that case it is convenient to locate an A/D converter and a D/A converter at the input and output, respectively, of the control unit. But control can be accomplished also on a purely electronic base.

The drive means for the rotatable Brewster element preferably comprises a galvanometric motor and especially a galvanometer scanner permitting quick acceleration and deceleration of the Brewster element and, as a result, quick adjustment of the desired angle.

It is also preferred to provide an input device for entering either a constant desired power value or a desired power value profile into the control means. In the preferred embodiment in which the control means is embodied by a processor, either a universal type computer or a dedicated computer may serve as the input device.

In another especially preferred embodiment of the invention and optical modulation system is arranged downstream of the measuring means in the propagation path of the laser beam. Most preferably, this system comprises an acousto-optical modulator. The modulation system supports the control means in returning the laser output power to a desired value when faster variations in laser intensity or leaps in the desired value are occurring. In such an event the modulation system changes its own operating cycle so as to lead the laser output power in the direction of the desired value. When the actual power value reaches the desired value the modulation system is set back to a predetermined operating cycle. The input signal received by the modulation system is the control differential between the desired power value and the actual power value so that the system will be able to react quickly to leaps in the desired power value or deviations from control. Provision of the modulation system makes it possible to adjust the power output of the laser beam still more quickly to a desired value than when using only Brewster elements. Moreover, the modulation system is employed whenever variable pulsed operation of the laser beam is desired.

The use of galvanometer scanners for rotating the rotable Brewster elements permits control times in the range of a few milliseconds to be achieved. These times can be reduced to half of the value mentioned or even less when the downstream modulation system is provided.

The rotatable Brewster element and the stationary Brewster element each preferably consist of a ZnSe plate which may be coated, for example, with a suitable antireflection film.

### SHORT DESCRIPTION OF DRAWINGS

The invention will be described further, by way of example, with reference to the accompanying drawings, in which:

FIG. 1 illustrates an example of a Brewster element to explain the behavior of a polarized laser beam which is reflected and transmitted, respectively, by the Brewster element;

FIG. 2 illustrates the Brewster element shown in FIG. 1, after having been turned by 90°;

FIG. 3 illustrates an arrangement composed of two Brewster elements to explain the behavior of a polarized laser beam incident on the Brewster elements;

FIG. 4 illustrates the arrangement composed of two Brewster elements shown in FIG. 3, after having been turned in synchronism in the same direction;

FIG. 5 is a diagrammatic presentation showing the quantity and direction of polarization of a laser beam passing through a rotatable Brewster element and a stationary Brewster element;

FIG. 6 is a diagrammatic presentation of a preferred embodiment of the control apparatus according to the invention.

### DETAILED DESCRIPTION OF PREFERRED EMBODIMENTS

Reference is made to FIG. 5 for an explanation of the function of a rotatable Brewster window in combination with a stationary Brewster window. FIG. 5 diagrammatically shows the rotatable Brewster window at 10 and the stationary Brewster window at 12. Double arrow A in FIG. 5 schematically shows the quantity and direction of polarization of a laser beam impinging on the rotatable Brewster window 10. Let it be assumed that the double arrow A corresponds to an output power of 100% and P polarization. This beam then is incident on the rotatable Brewster window, and it leaves the rotatable Brewster window 10, following rotation thereof by, for example, 45°, with a quantity and direction of polarization as illustrated diagrammatically by double arrow B. This double arrow B corresponds to the flank marked b of a rectangular triangle on double arrow A. The laser beam exiting from the rotatable Brewster window 10 impinges on the stationary Brewster window 12 to be attenuated further by the same, depending on its polarization direction. Therefore, a laser beam having a polarization direction and a quantity in accordance with double arrow C will exit the stationary Brewster window 12. The attenuation caused by the stationary Brewster window 12 depends on the preceding rotation of the polarization direction of the laser beam by the rotatable Brewster window 10. As may be taken from FIG. 5, the fixed Brewster window 12 brings the laser beam back into the original polarization plane and dampens the power of the laser beam in response to the incident polarization direction. Double arrow C corresponds to the flank marked c of a rectangular triangle on double arrow B.

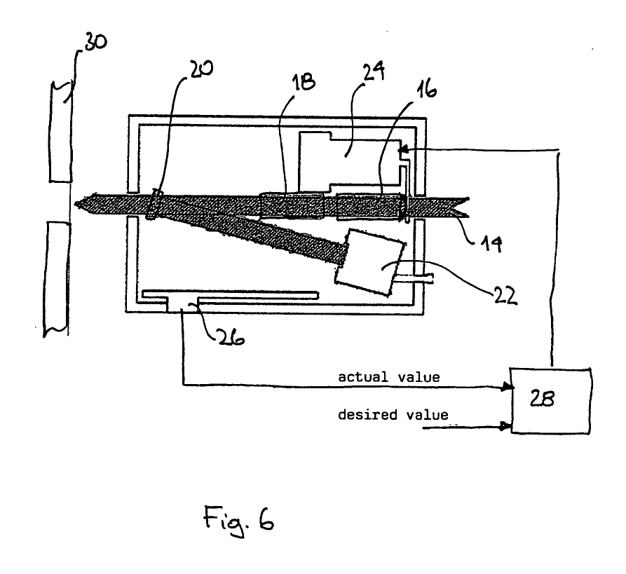

FIG. 6 is a diagrammatic illustration of a preferred embodiment of the control apparatus according to the invention. In FIG. 6 a linear polarized laser beam from a laser source (not shown) is designated 14. The laser source used in the preferred embodiment of the invention is a CO₂ laser. In the direction of its propagation (from right to left in the drawing) the laser beam first is incident on a rotatable Brewster plate 16, also referred to as active Brewster window, and then on a stationary Brewster window 18, also referred to as passsive Brewster window, and a beam splitter, e.g. a partly reflecting mirror which directs a defined portion of the laser beam 14 onto an active power meter 22. It is likewise possible to replace the single rotatable Brewster plate 16 by two Brewster plates (not shown) which are rotatable in opposite sense. Hereby the dynamic range of the control apparatus can be enlarged and a shorter reaction time of the control apparatus obtained at smaller angles of rotation per Brewster plate. In other words, the rotatable or active Brewster window may comprise one rotatable Brewster plate or two oppositely rotatable Brewster plates as disclosed, for instance, in German patent 101 54 363 by the same applicant. In FIG. 6, moreover, a drive means is shown diagrammatically, embodied by a galvanometer scanner 24, for rotating the rotatable Brewster window 16. An A/D converter is shown at 26, serving to convert the output signal of the active power meter 22 into a digital signal which then is taken over by a control means 28. The control means 28, for example, comprises a PID controller to receive input signals indicating the actual power value and a desired power value and to generate an adjustment signal to be applied to the galvanometer scanner 24. A D/A converter (not shown) may be provided at the output of the control means 28. The A/D converter and the D/A converter also may be integrated in the control means 28. The system illustrated in FIG. 6 operates as described below.

A CO₂ laser source or another laser source is coupled to the control apparatus shown and emits the laser beam 14, as may be seen in FIG. 6. The laser beam impinges on the rotatable Brewster window 16 and is either transmitted or reflected totally or partly by the same, depending on the position of the Brewster window 16. The underlying principle is that a Brewster window or Brewster plate, more generally Brewster element, the material and coating of which are adapted to the type and polarization direction of the laser source and the corresponding Brewster angle of which is adjusted in respect of the direction of beam propagation, will transmit or reflect a linear polarized laser beam in controllable fashion, depending on the angle of rotation of the Brewster window. For a CO₂ laser, for instance, Brewster plates are made of ZnSe and coated with suitable reflection reducing layers. The portion of the laser beam 14 passed by the rotatable Brewster window 16 impinges on the stationary Brewster window 18 to be either transmitted or reflected by the same, again in response to the polarization direction of the laser beam. Since the upstream Brewster window 16 rotates the polarization direction of the laser beam the transmission of the stationary Brewster window 18 is not constant but instead depends on the previous rotation. Next, the laser beam is incident on the partly reflecting mirror 20 which directs a defined portion of the laser beam into the active power meter 22. In the active power meter 22, the power or intensity of the laser beam is determined as the actual power value. Upon conversion into a digital signal, the value is applied to the control means as the digital actual power value. The control means 28, at the same time, receives a desired power value or a desired power value profile and provides a control differential of the actual power value and the desired power value. This control differential becomes the input signal applied to a PID controller, in other words a controller with proportional integral, and differential portions. The P-, I-, and D-shares of the controller may be weighted differently, depending on the selected control algorithm. If the actual power value differs from the desired power value the control means 28 generates an adjustment signal for the galvanometer scanner 24 which then rotates the rotatable Brewster window 16 accordingly in order to compensate the control deviation.

The proposed control apparatus makes it possible to achieve short control times in the range of a few milliseconds for adjusting the actual power value in case there are leaps in the desired power values or variations in the power output of the CO₂ laser. Laser-bound power variations can be limited in practice to <0.3% of the laser power output. The stationary Brewster window 18 serves the purpose of bringing back the polarization direction of the laser beam 14 to the original polarization direction and of causing further attenuation of the laser beam. The latter, in turn, depends on the angle of rotation of the rotatable Brewster window.

In a modification of the embodiment of the invention illu-strated in FIG. 6, another stationary Brewster window (not shown) may be provided between the laser source and the rotatable Brewster window 16 in addition to the stationary Brewster window 18 to correct the polarization direction of the laser beam emitted by the laser source, if necessary. As explained above, a CO₂ laser emitting linear polarized light is used in the preferred embodiment of the invention. Due to manufacturing conditions, however, the polarization direction of such a laser not always lies in a predetermined polarization plane. Thus a second stationary Brewster window located at the exit of the laser source can make sure that the polarization direction will lie in the desired polarization plane so that the control apparatus according to the invention can operate with precision.

Moreover, a safety shutter, of the water cooled type, for instance, may be provided at the output of the control means in other words downstream of the partly reflecting mirror 20, to thereby limit the control means in the direction of the target. Furthermore, the control apparatus may comprise beam dumps to catch those shares of the laser beam which were reflected by the Brewster window.

In another preferred embodiment of the invention, a modulation system, and particularly an acousto-optical modulator, is connected downstream of the control means, as indicated diagrammatically at 30 in FIG. 6. The acousto-optical modulator may be used to emit a pulsed laser beam, if desired. Moreover, the acousto-optical modulator can support and accelerate quick adjustment of the laser beam power when the stability of the laser source varies greatly or rapidly and when leaps occur in the desired value. To that end, the clock cycle of the acousto-optical modulator would be changed if a control deviation exceeding a certain threshold value were determined. In this manner the laser power could be adjusted more quickly than the control system alone would be able to accomplish. It is likewise conceivable to use another switching or modulating system instead of an acousto-optical modulator, e.g. a power control system as disclosed in the above mentioned protective rights by the same applicant.

The features disclosed in the specification above, in the claims and drawings may be significant for implementing the invention in its various embodiments, both individually and in any combination.

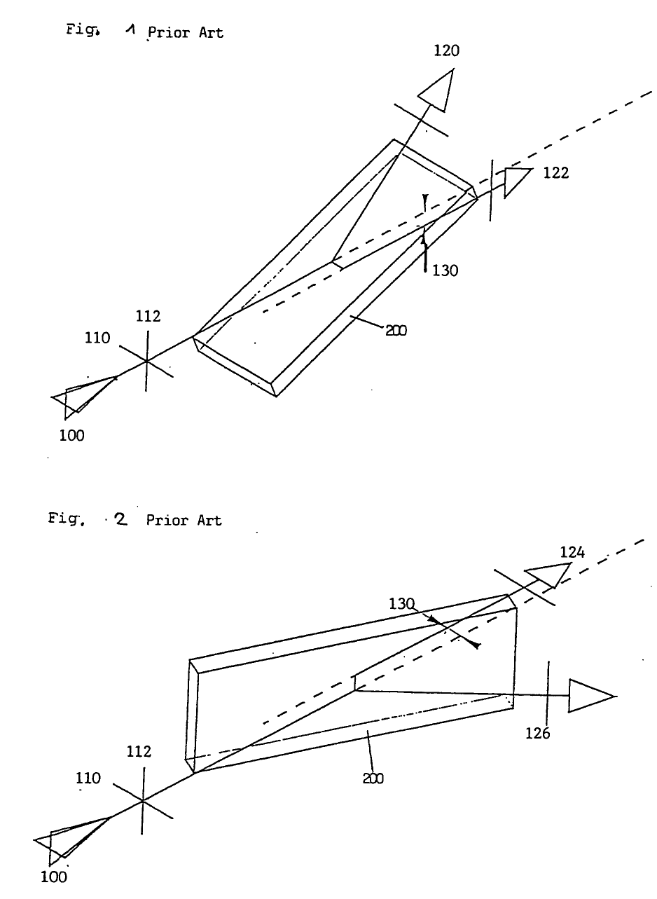

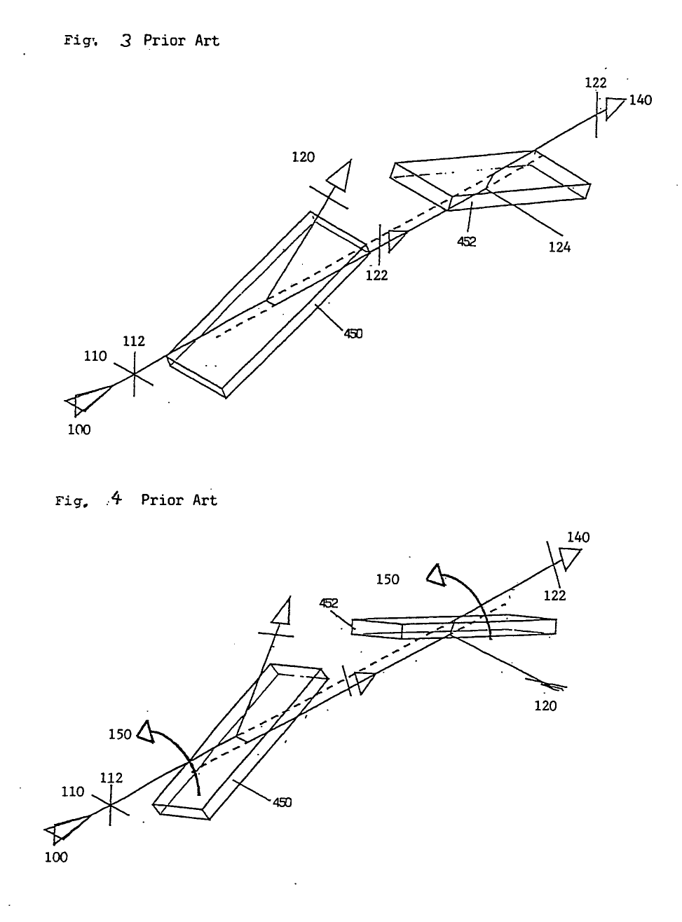

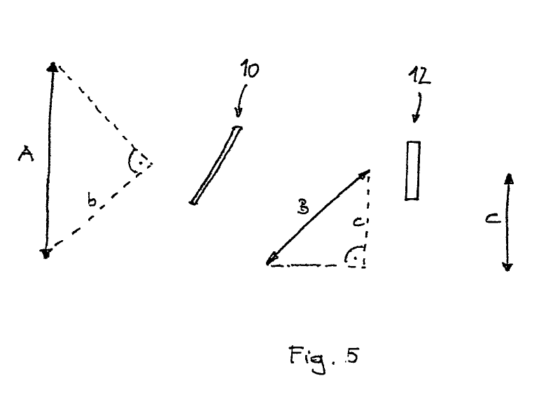

List of reference numerals used in FIGS. 1 to 4
entering beam
P pol
S pol
120 P pol reflection
122 P pol transmission
124 P pol transmission
126 S pol reflection
130 offset
140 exiting beam
150 rotation

1. An apparatus for controlling the power of a laser beam (14), comprising
a Brewster element (16) aligned along an axis parallel to the direction of the laser beam (14) and disposed in the propagation path of the laser beam (14);
a drive means (24) to rotate the Brewster element (16) about said axis;
a measuring means (22) to determine the power of the laser beam (14) downstream of the rotatable Brewster element (16) and to generate an actual power value; and
a control means (28) having an input connected to the measuring means (22) and an output connected to the drive means (24), the control means (28) receiving the actual power value and a desired power value to generate and output a control value,
wherein the drive means (24) rotates the Brewster element (16) in response to the control value to minimize the difference between the actual power value and the desired power value.

2. The apparatus as claimed in claim 1, wherein at least one stationary Brewster element (18) is disposed in the propagation path of the laser beam (14) upstream of the rotatable Brewster element (16).

3. The apparatus as claimed in claim 1, wherein the measuring means comprises a power meter (22) and a beam splitter (20), the beam splitter (20) being disposed in the propagation path of the laser beam (14) and directing a defined portion of the laser beam (14) onto the active power meter (22).

4. The apparatus as claimed in claim 1, wherein the control means (28) comprises a PID controller.

5. The apparatus as claimed in claim 1, wherein the drive means (24) comprises a galvanometer scanner.

6. The apparatus as claimed in claim 1, further comprising an input device to input a desired power value a into the control means (28).

7. The apparatus as claimed in claim 1, wherein an optical modulation system (30) is disposed downstream of the measuring means (22) in the propagation path of the laser beam (14).

8. The apparatus as claimed in claim 7, wherein the modulation system (30) is adapted to be driven in response to the desired power value or a control differential.

9. The apparatus as claimed in claim 7, wherein the modulation system (30) is connected to the control means (28).

10. The apparatus as claimed in claim 7, wherein the modulation system (30) comprises an acousto-optical modulator.

11. The apparatus as claimed in claim 1, wherein a second rotatable Brewster element is associated with the rotatable Brewster element (16), said second rotatable Brewster element arranged adjacent to the first rotatable Brewster element (16) along the same axis in the propagation path of the laser beam (14).

12. The apparatus as claimed in claim 11, wherein the first (16) and second rotatable Brewster elements are rotatable in opposite directions.

13. The apparatus as claimed in claim 12, wherein the first (16) and second rotatable Brewster elements each are rotatable through about 0 to +45 degrees and 0 to −45 degrees, respectively.

14. The apparatus as claimed in claim 1, wherein the rotatable Brewster element (16) is made of ZnSe and coated with an antireflection film.

15. The apparatus as claimed in claim 1, wherein an A/D converter (26) is disposed at the input of the control means (28) and a D/A converter is disposed at the output of the control means (28).

16. The apparatus as claimed in claim 1, further comprising a laser source for generating a linear polarized laser beam (14).

17. The apparatus as claimed in claim 1, futher comprising a CO₂ laser source for generating the laser beam.

18. The apparatus as claimed in claim 1, wherein at least one stationary Brewster element (18) is disposed in the propagation path of the laser beam (14) downstream of the rotatable Brewster element (16).

19. The apparatus of claim 6 wherein said desired power value is a constant.

20. The apparatus of claim 6 wherein said desired power value has a predetermined profile.

21. A method for controlling the power of a laser comprising the steps of:
providing a first Brewster element aligned along an axis in parallel with the direction of the laser and disposed in the propagation path of the laser;
generating an actual power value representative of the measured power of the laser;
generating a control value representative of a difference between the actual power value and a desired power value; and
rotating the first Brewster element responsive to the control value to thereby control the power of the laser.

22. The method of claim 21 further comprising the step of modulating the laser responsive to the desired power value of the laser.

23. The method of claim 21 further comprising the step of modulating the laser responsive to the control value.

24. The method of claim 21 further comprising the step of providing a second Brewster element arranged adjacent to the first Brewster element along the same axis in the propagation path of the laser.

25. The method of claim 24 further comprising the step of rotating the first and second Brewster elements in opposite directions.

26. The method of claim 25 wherein the first and second Brewster elements are rotated synchronously.

27. The method of claim 21 further comprising the step of generating a linearly polarized laser.

28. A method of compensating for instabilities in an optical system having a laser beam comprising the steps of:
providing at least one Brewster element along an axis parallel with the direction of the laser beam and disposed in the propagation path of the laser beam; and
rotating the at least one Brewster element responsive to a difference between an actual power value of the laser beam and a desired power value of the laser beam to thereby compensate for instabilities in the system.

29. The method of claim 28 further comprising the step of modulating the laser beam responsive to a desired power value of the laser beam.

30. The method of claim 28 further comprising the step of providing a second Brewster element arranged adjacent to the at least one Brewster element along the same axis in the propagation path of the laser.

31. The method of claim 30 further comprising the step of rotating the Brewster elements in opposite directions.

32. A method for controlling a transmission property of a light beam comprising the steps of:
providing at least one Brewster element aligned along an axis in parallel with the direction of the light beam and disposed in the propagation path of the light beam;
generating an actual power value representative of the power of the light beam;
generating a control value representative of a difference between the actual power value and a desired power value; and
rotating the at least one Brewster element responsive to the control value to thereby control the transmission properties of the light beam.

33. The method of claim 32 further comprising the step of modulating the light beam responsive to the desired power value of the light beam.

34. The method of claim 32 further comprising the step of providing a second Brewster element arranged adjacent to the at least one Brewster element along the same axis in the propagation path of the light beam.

35. The method of claim 34 further comprising the step of rotating the Brewster elements in opposite directions.

36. The method of claim 35 wherein the Brewster elements are rotated synchronously.
